(19) United States
(12) Patent Application Publication
(10) Pub. No.: US 2022/0405682 A1
(43) Pub. Date: Dec. 22, 2022

(54) INVERSE REINFORCEMENT LEARNING-BASED DELIVERY MEANS DETECTION APPARATUS AND METHOD

(71) Applicant: WOOWA BROTHERS CO., LTD., Seoul (KR)

(72) Inventors: Dae Young Yoon, Seoul (KR); Jae ll Lee, Yongin-si (KR); Tae Hoon Kim, Seoul (KR)

(21) Appl. No.: 17/756,066

(22) PCT Filed: Sep. 7, 2020
(86) PCT No.: PCT/KR2020/012019

§ 371 Date: May 16, 2022

(30) Foreign Application Priority Data
Aug. 26, 2020 (KR) 10-2020-0107780

(51) Int. Cl. G06Q 10/06; G06N 3/04

(52) U.S. Cl. CPC G06Q 10/06398; G06N 3/04

(57) ABSTRACT

In an inverse reinforcement learning-based delivery means detection apparatus and method according to a preferred embodiment of the present invention, an artificial neural network model may be trained by using an actual deliveryman's driving record and imitated driving record, and from a specific deliveryman's driving record, a delivery means of the corresponding deliveryman may be detected by using the trained artificial neural network model, so that a deliveryman suspected of being abusive may be identified.

### TECHNICAL FIELD

The present invention relates to an inverse reinforcement learning-based delivery means detection apparatus and method, and more particularly, to an apparatus and method for training an artificial neural network model using a driving record of an actual delivery worker and an imitated driving record and detecting a delivery means of a specific delivery worker from a driving record of the specific delivery worker using the trained artificial neural network model.

### BACKGROUND ART

The online food delivery service industry has grown significantly over the past few years, and accordingly, the need for delivery worker management is also increasing. Most conventional food delivery is done by crowdsourcing delivery workers. Crowdsourcing delivery workers deliver food by motorcycle, bicycle, kickboard or car, or on foot. Among these delivery workers, there are abusers who register a bicycle or a kickboard as their delivery vehicles but carry out a delivery by motorcycle.

FIG. 1 is a diagram illustrating the overall process of an online food delivery service.

Referring to FIG. 1, first, a user orders food through an application or the like, and a system delivers the order to the restaurant. Then, the system searches for and assigns a suitable delivery worker to deliver the food, and the assigned delivery worker picks up the food and delivers it to the user. In such a food delivery process, when the system assigns a delivery to an abuser, a delivery worker abuse problem may occur. Due to distance restrictions, the system often assigns short-distance deliveries to bicycle, kickboard, or walking delivery workers. Therefore, the unauthorized use of motorcycles can be beneficial to abusers by enabling more deliveries in less time. In addition, this can lead to serious problems in the event of a traffic accident because tailored insurance is provided for the types of registered delivery vehicles specified in the contract. Therefore, it is becoming important to provide a fair opportunity and a safe operating environment to all delivery workers by detecting and catching these abusers.

### DISCLOSURE

### Technical Problem

The present invention is directed to providing an inverse reinforcement learning-based delivery detection apparatus and method for training an artificial neural network model using a driving record of an actual delivery worker and an imitated driving record and detecting a delivery means of a specific delivery worker from a driving record of the delivery worker using the trained artificial neural network model.

Other objects not specified in the present invention may be additionally considered within the scope that can be easily inferred from the following detailed description and effects thereof.

### Technical Solution

An inverse reinforcement learning-based delivery means detection apparatus according to a desirable embodiment of the present invention for achieving the above object includes a reward network generation unit configured to generate a reward network that outputs a reward for an input trajectory using, as training data, a first trajectory including a pair of a state, which indicates a current static state, and an action, which indicates an action dynamically taken in the state, and a second trajectory including a pair of the state of the first trajectory and an action imitated based on the state of the first trajectory and a delivery means detection unit configured to acquire a reward for a trajectory to be detected from the trajectory to be detected using the reward network and detect a delivery means for the trajectory to be detected on the basis of the reward for the trajectory to be detected.

Here, the reward network generation unit may generate a policy agent configured to output an action for an input state using the state of the first trajectory as training data, acquire an action for the state of the first trajectory through the policy agent, and generate the second trajectory on the basis of the state of the first trajectory and the acquired action.

Here, the reward network generation unit may update the weight of the policy agent through a proximal policy optimization (PPO) algorithm on the basis of a second reward for the second trajectory acquired through the reward network.

Here, the reward network generation unit may acquire a distributional difference between rewards on the basis of a first reward for the first trajectory acquired through the reward network and a second reward for the second trajectory acquired through the reward network and may update the weight of the reward network.

Here, the reward network generation unit may acquire the distributional difference between rewards through an evidence of lower bound (ELBO) optimization algorithm on the basis of the first reward and the second reward and update the weight of the reward network.

Here, the reward network generation unit may initialize the weight of the reward network and the weight of the policy agent using a Gaussian distribution and generate the reward network and the policy agent through an iterative learning process.

Here, the reward network generation unit may select a portion of the second trajectory as a sample through an importance sampling algorithm, acquire, from the first trajectory, a sample corresponding to the portion of the second trajectory selected as the sample, and generate the reward network using, as training data, the portion of the first trajectory acquired as the sample and the portion of the second trajectory acquired as the sample.

Here, the delivery means detection unit may acquire a novelty score by normalizing the reward for the trajectory to be detected and may detect a delivery means for the trajectory to be detected on the basis of the novelty score for the trajectory to be detected and a mean absolute deviation (MAD) acquired based on the novelty score.

The state may include information on latitude, longitude, interval, distance, speed, cumulative distance, and cumulative time, the action may include information on velocity in the x-axis direction, velocity in the y-axis direction, and acceleration, and the first trajectory may be a trajectory acquired from a driving record of an actual delivery worker.

A delivery means detection method performed by an inverse reinforcement learning-based delivery means detection apparatus according to a desirable embodiment of the present invention for achieving the above object includes steps of generating a reward network that outputs a reward for an input trajectory using, as training data, a first trajectory including a pair of a state, which indicates a current static state, and an action, which indicates an action that is dynamically taken in the state, and a second trajectory including a pair of the state of the first trajectory and an action imitated based on the state of the first trajectory; and acquiring a reward for a trajectory to be detected from the trajectory to be detected using the reward network and detecting a delivery means for the trajectory to be detected on the basis of the reward for the trajectory to be detected.

Here, the step of generating the reward network may include generating a policy agent configured to output an action for an input state using the state of the first trajectory as training data, acquiring an action for the state of the first trajectory through the policy agent, and generating the second trajectory on the basis of the state of the first trajectory and the acquired action.

Here, the step of generating the reward network may include updating the weight of the policy agent through a proximal policy optimization (PPO) algorithm on the basis of a second reward for the second trajectory acquired through the reward network.

Here, the step of generating the reward network may include acquiring a distributional difference between rewards on the basis of a first reward for the first trajectory acquired through the reward network and a second reward for the second trajectory acquired through the reward network and updating the weight of the reward network.

Here, the step of generating the reward network may include selecting a portion of the second trajectory as a sample through an importance sampling algorithm, acquiring, from the first trajectory, a sample corresponding to the portion of the second trajectory selected as the sample, and generating the reward network using, as training data, the portion of the first trajectory acquired as the sample and the portion of the second trajectory acquired as the sample.

A computer program according to a desirable embodiment of the present invention for achieving the above object is stored in a computer-readable recording to execute, in a computer, the inverse reinforcement learning-based delivery means detection method.

### Advantageous Effects

With the inverse reinforcement learning-based delivery detection apparatus and method according to desirable embodiments of the present invention, it is possible to train an artificial neural network model using a driving record of an actual delivery worker and an imitated driving record and detect a delivery means of a specific delivery worker from a driving record of the delivery worker using the trained artificial neural network model, thereby identifying a delivery worker suspected of a abuser.

The effects of the present invention are not limited to those described above, and other effects that are not described herein will be apparently understood by those skilled in the art from the following description.

### DESCRIPTION OF DRAWINGS

FIG. 1 is a diagram illustrating the overall process of an online food delivery service.

FIG. 2 is a block diagram showing a configuration of an inverse reinforcement learning-based delivery means detection apparatus according to a desirable embodiment of the present invention.

FIG. 3 is a diagram illustrating a process of generating a reward network according to a desirable embodiment of the present invention.

FIG. 4 is a diagram illustrating a detailed configuration of a reward network shown in FIG. 3.

FIG. 5 is a flowchart illustrating the steps of an inverse reinforcement learning-based delivery means detection method according to a desirable embodiment of the present invention.

FIG. 6 is a flowchart illustrating the sub steps of a reward network generation step shown in FIG. 5.

FIG. 7 is a flowchart illustrating the sub steps of a delivery means detection step shown in FIG. 5.

FIGS. 8A and 8B are diagrams illustrating the performance of an inverse reinforcement learning-based delivery means detection operation according to a desirable embodiment of the present invention.

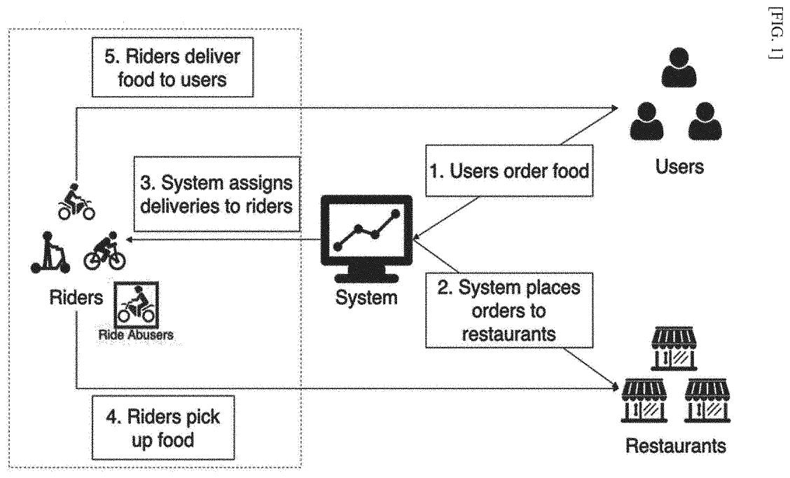

### MODE FOR CARRYING OUT THE INVENTION

Hereinafter, the embodiments of the present invention will be described in detail with reference to the accompanying drawings. Advantages and features of the present invention and methods of accomplishing the same may be understood more readily with reference to the following detailed description of embodiments and the accompanying drawings. However, the present invention is not limited to embodiments disclosed herein and may be implemented in various different forms. The embodiments are provided for making the disclosure of the prevention invention thorough and for fully conveying the scope of the present invention to those skilled in the art. It is to be noted that the scope of the present invention is defined by the claims. Like reference numerals refer to like elements throughout.

Unless otherwise defined, all terms (including technical and scientific terms) used herein have the same meanings as commonly understood by one of ordinary skill in the art to which this invention belongs. Also, terms defined in commonly used dictionaries should not be interpreted in an idealized or overly formal sense unless expressly so defined herein.

Herein, terms such as “first” and “second” are used only to distinguish one element from another element. The scope of the present invention should not be limited by these terms. For example, a first element could be termed a second element, and, similarly, a second element could be termed a first element.

Herein, identification symbols (e.g., a, b, c, etc.) in steps are used for convenience of description and do not describe the order of the steps, and the steps may be performed in a different order from a specified order unless the order is clearly specified in context. That is, the respective steps may be performed in the same order as described, substantially simultaneously, or in reverse order.

Herein, the expression “have,” “may have,” “include,” or “may include” refers to a specific corresponding presence (e.g., an element such as a number, function, operation, or component) and does not preclude additional specific presences.

Also herein, the term “unit” refers to a software element or a hardware element such as a field-programmable gate array (FPGA) or an ASIC, and a “unit” performs any role. However, a “unit” is not limited to software or hardware. A “unit” may be configured to be in an addressable storage medium or to execute one or more processors. Therefore, for example, “unit” includes elements, such as software elements, object-oriented software elements, class elements, and task elements, processes, functions, attributes, procedures, sub routines, segments of program code, drivers, firmware, microcode, circuits, data structures, and variables. Furthermore, functions provided in elements and “units” may be combined as a smaller number of elements and “units” or further divided into additional elements and “units.”

Hereinafter, with reference to the accompanying drawings, desirable embodiments of an inverse reinforcement learning-based delivery means detection apparatus and method according to the present invention will be described in detail.

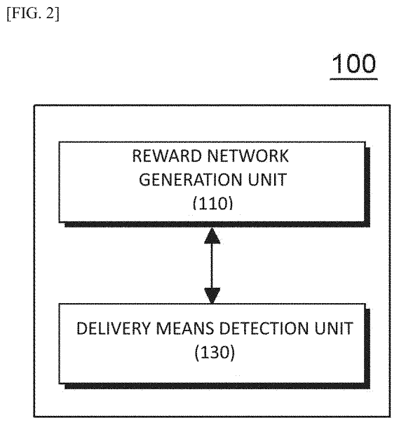

First, the inverse reinforcement learning-based delivery means detection apparatus according to a desirable embodiment of the present invention will be described with reference to FIG. 2.

FIG. 2 is a block diagram showing a configuration of an inverse reinforcement learning-based delivery means detection apparatus according to a desirable embodiment of the present invention.

Referring to FIG. 2, the inverse reinforcement learning-based delivery means detection apparatus (hereinafter referred to as a delivery means detection apparatus) 100 according to a desirable embodiment of the present invention may train an artificial neural network model using a driving record of an actual delivery worker and an imitated driving record and detect a delivery means of a specific delivery worker from a driving record of the specific delivery worker (i.e., identify a driving record for which abuse is suspected) using the trained artificial intelligence network model. This allows a delivery worker who is suspected of abuse to be identified and can also be used to make a decision to ask the delivery worker for an explanation.

To this end, the delivery means detection apparatus 100 may include a reward network generation unit 110 and a delivery means detection unit 130.

The reward network generation unit 110 may train the artificial intelligence network model using the driving record of the actual delivery worker and the imitated driving record.

That is, the reward network generation unit 110 may generate a reward network configured to output a reward for an input trajectory using a first trajectory and a second trajectory as training data.

Here, the first trajectory is a trajectory acquired from the driving record of the actual delivery worker and may include a state-action pair. The state indicates the current static state of the delivery worker and may include information on latitude, longitude, interval, distance, speed, cumulative distance, and cumulative time. The action indicates an action taken dynamically by the delivery worker in the corresponding state and may include information on velocity in the x-axis direction, velocity in the y-axis direction, and acceleration. For example, when the state is “interval=3 seconds & speed=20 m/s,” an action that can be taken in the state in order to increase the speed may be “acceleration=30 m/s²” or “acceleration=10 m/s².”

The second trajectory is a trajectory obtained by imitating the action from the state of the first trajectory and may include the state of the first trajectory and the action imitated based on the state of the first trajectory. In this case, the reward network generation unit 110 may use the state of the first trajectory as training data to generate a policy agent configured to output an action for an input state. The reward network generation unit 110 may acquire an action for the state of the first trajectory through the policy agent and may generate the second trajectory on the basis of the state of the first trajectory and the acquired action.

In this case, the reward network generation unit 110 may select a portion of the second trajectory as a sample through an importance sampling algorithm, acquire, from the first trajectory, a sample corresponding to the portion of the second trajectory selected as the sample, and generate the reward network using, as training data, the portion of the first trajectory acquired as the sample and the portion of the second trajectory acquired as the sample. Here, the importance sampling is a scheme of giving a higher probability of sampling to a less learned sample and may be calculated as a reward for an action equal to the probability of the policy agent selecting the action. For example, assuming one action is “a,” the probability that “a” will be sampled becomes the probability of choosing (reward for “a”)/“a.”

In addition, the reward network generation unit 110 may initialize the weight of the reward network and the weight of the policy agent using a Gaussian distribution and may generate the reward network and the policy agent through an iterative learning process.

In this case, the reward network generation unit 110 may acquire a distributional difference between rewards on the basis of a first reward for the first trajectory acquired through the reward network and a second reward for the second trajectory acquired through the reward network and may update the weight of the reward network. For example, the reward network generation unit 110 may acquire the distributional difference between rewards on the basis of the first reward and the second reward through the evidence of lower bound (ELBO) algorithm and may update the weight of the reward network. That is, the ELBO may be calculated through a method of calculating a distributional difference in distribution called Kullback-Leibler (KL) divergence. The ELBO theory explains that the method of minimizing divergence is a method of increasing the lower bound of the distribution and that it is possible to ultimately reduce the distribution gap by increasing the minimum value. Accordingly, in the present invention, the lower bound becomes the distribution of the reward of the policy agent, and the distribution for finding the difference becomes the distribution of the reward of the actual delivery worker (expert). By acquiring the distributional difference between the two rewards, the ELBO may be acquired. Here, the reason for inferring the distribution of the reward is that the action and the state of the policy agent are continuous values, not discrete values in statistical theory.

Also, the reward network generation unit 110 may update the weight of the policy agent on the basis of the second reward for the second trajectory acquired through the reward network. Also, the reward network generation unit 110 may update the weight of the policy agent on the basis of the second reward through a proximal policy optimization (PPO) algorithm.

The delivery means detection unit 130 may detect a delivery means of a specific delivery worker from a driving record of the delivery worker using the artificial neural network model trained through the reward network generation unit 110.

That is, the delivery means detection unit 130 may acquire a reward for a trajectory to be detected from the trajectory to be detected using the reward network generated through the reward network generation unit 110 and may detect a delivery means for the trajectory to be detected on the basis of the reward for the trajectory to be detected.

For example, the delivery means detection unit 130 may acquire a novelty score by normalizing the reward for the trajectory to be detected and may detect a delivery means for the trajectory to be detected on the basis of the novelty score for the trajectory to be detected and a mean absolute deviation (MAD) acquired based on the novelty score. In other words, when a novelty is found using the MAD, since delivery workers with motorcycles are originally supposed to receive high rewards, the delivery means detection unit 130 may detect, as a delivery worker suspected of abuse, a delivery worker who has exceeded the MAD by more than a predetermined number (5%, 10%, etc.) in proportion to the entire trajectory.

As described above, the delivery means detection apparatus 100 according to the present invention imitates the action characteristics of a motorcycle delivery worker through a reinforcement learning policy agent configured using an artificial neural network, and an inverse reinforcement learning reward network (i.e., a reward function) configured using an artificial neural network modeling a distributional difference between an action pattern imitated by the policy agent and an actual action pattern of the motorcycle delivery worker (i.e., expert) and assigns a reward to the policy agent. A process of modeling this distributional difference is called variational inference. By repeatedly performing this process, the policy agent and the reward network are simultaneously trained through interaction. As the training is repeated, the policy agent adopts an action pattern similar to that of the motorcycle delivery worker, and the reward network learns to give a corresponding reward. Finally, rewards for the action patterns of delivery workers to be detected are extracted using the trained reward network. Through the extracted reward, it is classified whether the corresponding action pattern corresponds to use of a motorcycle or use of other delivery means. It is possible to find a delivery worker suspected of abuse through the classified delivery means.

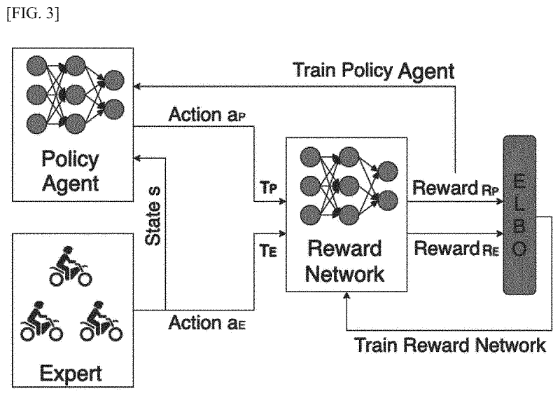

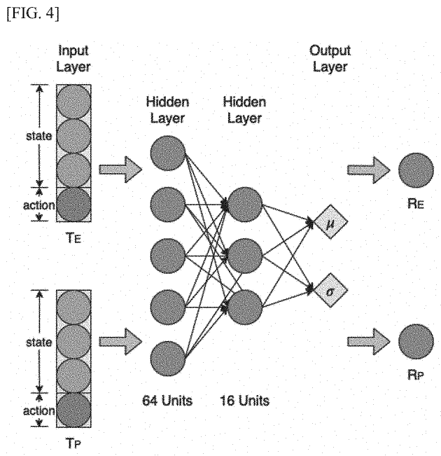

Next, the inverse reinforcement learning-based delivery means detection operation according to a desirable embodiment of the present invention will be described in detail with reference to FIGS. 3 and 4.

FIG. 3 is a diagram illustrating a process of generating a reward network according to a desirable embodiment of the present invention, and FIG. 4 is a diagram illustrating a detailed configuration of a reward network shown in FIG. 3.

Reinforcement Learning (RL)

The present invention considers Markov decision processes (MDP) defined by a tuple <S, A, P, R, p₀, γ>, where S is a set of finite states and is a set of a finite set of actions, and P(s, a, s′) denotes the transition probability of a change from state “s” to state “s′.” When action “a” occurs, r(s, a) denotes an immediate reward for action “a” occurring in state “s,” p₀ is an initial state distribution p₀:S→R, and γ∈ (0, 1) denotes a discount factor for modeling latent future rewards. A stochastic policy mapping for possible actions from state to distribution is defined as π:S×A→[0, 1]. The value of a policy π performed in state “S” is defined as expectation V [symbol] (s)=E[Σ^{∞}ₜ₌₀γ^{t}rₜ+1|s], and the goal of the reinforcement learning agent is to find an optimal policy π* which maximizes the expectation of all possible states.

Inverse Reinforcement Learning (IRL)

In contrast to the RL above, the reward function should be explicitly modeled within the MDP, and the goal of the IRL is to estimate an optimal reward function R* from the demonstration of an expert (i.e., an actual delivery worker). For this reason, the RL agent is required to imitate the expert's action using the reward function found by the IRL. Trajectory T denotes a sequence of state-action pairs T=(s₁, a₁), (s₂, a₂), . . . , (sₜ, aₜ), and T_{E} and T_{P} denote trajectories of the expert and trajectories generated by the policy, respectively. Using the trajectories of the expert and the policy, the reward function should learn an accurate reward representation by optimizing the expectations of the rewards of both the expert and the policy.

$$\text{?} \qquad [ Formula 1 ]$$

$$\text{?} \text{indicates text missing or illegible when filed}$$

Maximum Entropy IRL

The maximum entropy IRL models expert demonstration using a Boltzmann distribution, and the reward function is modeled as a parameterized energy function of the trajectories as expressed in Formula 2 below.

$$\text{?} \qquad [ Formula 2 ]$$

$$\text{?} \text{indicates text missing or illegible when filed}$$

Here, R is parameterized by θ and defined as R(τ|θ)=Σ^{τ}ₜ₌₀r₀(sₜ,aₜ). This framework assumes that the expert trajectory is close to an optimal trajectory with the highest likelihood. In this model, optimal trajectories defined in a partition function Z are exponentially preferred. Since determining the partition function is a computationally difficult challenge, early studies in the maximum entropy IRL suggested dynamic programming in order to compute Z. More recent approaches focus on approximating Z with unknown dynamics of MDP by deleting samples according to importance weights or by applying importance sampling.

Operating Process of Present Invention

Based on the maximum entropy IRL framework, the present invention formulates ride abuser detection as a posterior estimation problem of the distribution for all possible rewards for novelty detection. The overall process of reward learning according to the present invention is shown in FIG. 3. The main process of the present invention is as follows.

First, the policy π repeatedly generates trajectories T_{P} to imitate the expert. Then, assuming that the rewards follow a Gaussian distribution, the present invention samples reward values from the learned parameters of a posterior distribution with μ and σ. Given that the sampled rewards are assumed to be a posterior representation, policy π may be updated for the sampled rewards, and the reward parameters may be updated by optimizing the variational bound, known as the ELBO of the two different expectations (posterior expectations of rewards for given T_{E} and T_{P}). As shown in FIG. 4, the reward network outputs R_{E} and R_{P} from T_{E} and T_{P}, respectively.

The approach of the present invention is parametric Bayesian inference, which views each node of the neural network as a random variable to acquire uncertainty.

The present invention assumes that it is more efficient to use parametric variational inference when optimizing the ELBO compared to the previous models that use bootstrapping or Monte Carlo dropout which uses Markov chain Monte Carlo (MCMC) to derive a reward function space.

Bayesian Formulation

Assuming that rewards are independent and identically distributed (i.i.d.), the present invention can focus on finding the posterior distribution of the rewards. Using the Bayes theorem, the present invention can formulate the posterior as expressed in Formula 3 below.

$$\text{?} \qquad [ Formula 3 ]$$

$$\text{?} \text{indicates text missing or illegible when filed}$$

Here, the prior distribution p(r) is known as the background of the reward distribution. In the present invention, it is assumed that the prior knowledge of the reward is a Gaussian distribution. The likelihood term is defined in [Formula 2] by the maximum entropy IRL. This may also be interpreted as a preferred action of policy π for given states and rewards corresponding to a trajectory line. Since it is not possible to measure this likelihood due to the intractability of the partition function Z, the present invention estimates the partition function through Section below.

Variational Reward Inference

In a variational Bayesian study, posterior approximation is often considered an ELBO optimization problem.

$$\text{?} \qquad [ Formula 4 ]$$

$$\text{?} \text{indicates text missing or illegible when filed}$$

Here, Φ denotes learned parameters for the posterior approximation function q, z is a collection of values sampled from the inferred distribution, and p(x|z) is the posterior distribution for a given z.

In variational Bayesian settings, Z denotes latent variables sampled from the learned parameters. Then, minimizing the Kullback-Leibler divergence (D_{KL}) between the approximated posterior q_{Φ}(z|x) and the generated distribution p(z) may be considered as maximizing the ELBO. Instead of using Z as latent variables, the present invention uses the latent variables as parameters of the approximated posterior distribution.

When this is applied to the present invention, the expectation term may be reformulated as expressed in Formula 5 below.

$$\text{?} \qquad [ Formula 5 ]$$

$$\text{?} \text{indicates text missing or illegible when filed}$$

The log-likelihood term inside the expectation is necessarily the same as applying the logarithm to the likelihood defined in Formula 2. Accordingly, estimating the expectation term also fulfills the need for z estimation. Unlike the previous approaches that estimate Z within the likelihood term using backup trajectory samples together with MCMC, the present invention uses the learned parameters to measure the difference in posterior distribution between expert rewards and policy rewards. Then, the log-likelihood term may be approximated using a marginal Gaussian log-likelihood (GLL). Since a plurality of parameters may be used when a plurality of features of the posterior are assumed, the present invention may use the mean of a plurality of GLL values. Then, ELBO in Formula 4 may be represented as expressed in Formula 6 below.

$$\text{?} \qquad [ Formula 6 ]$$

$$\text{?} \text{indicates text missing or illegible when filed}$$

Here, D_{KL} is obtained by measuring the distributional difference between the posterior and the prior, and the prior distribution is set as a zero-mean Gaussian distribution.

Gradient Computation

Since there is no actual data on the posterior distribution of the rewards, the present invention uses the rewards of the expert trajectory as the posterior expectation when calculating the ELB O. A conventional process of computing a gradient with respect to a reward parameter θ is as expressed in Formula 7 below.

$$\text{?} \qquad [ Formula 7 ]$$

$$\text{?} \text{indicates text missing or illegible when filed}$$

Since it is not possible to compute the posterior using the sampled rewards, the present invention uses a reparameterization technique, which allows the gradient to be computed using the learned parameters of the posterior distribution. Using the reparameterization technique, the present invention may estimate the gradient as expressed in Formula 8 below.

$$\text{?} \qquad [ Formula 8 ]$$

$$\text{?} \text{indicates text missing or illegible when filed}$$

The present invention may also apply an importance sampling technique, which selects samples on the basis of an importance defined so that only important samples are applied to compute the gradient.

Using importance sampling, trajectories with higher rewards are more exponentially preferred. When a weight term is applied to the gradient, the present invention can acquire Formula 9 below.

$$\text{?} \qquad [ Formula 9 ]$$

$$\text{?} \text{indicates text missing or illegible when filed}$$

Here, wᵢ=exp(R(τᵢ|θ)/q(τᵢ), μ [symbol] =1/|W|Σ^{|W|}ᵢwᵢr [symbol] ′, and μ [symbol] =1/|W|Σ^{|W|}ᵢ′, q(τᵢ) denotes the log probability of the policy output for τᵢ.

In order to ensure that only pairs of sampled trajectories are updated through the gradient in each training step during the training process, the present invention may also use importance sampling to match expert trajectories to the sampled policy trajectories.

Operation Algorithm of Present Invention

The present invention aims to learn the actions of a group of motorcycle delivery workers in order to identify abusers registered as non-motorcycle delivery workers. Accordingly, the present invention infers the distribution of rewards for given expert trajectories of motorcycle delivery workers. To ensure that the reward function according to the present invention is trained from the actions of the motorcycle delivery worker in order to distinguish between a non-abuser action that uses a vehicle normally and other actions of an abuser who uses a motorcycle, it is important that the training set should not contain latent abusers.

First, the present invention initializes a policy network π and a reward learning network parameter θ using a zero-mean Gaussian distribution, and expert trajectories T_{E}={τ₁, τ₂, . . . , τₙ} are given from a dataset. At each iteration process, the policy π generates a sample policy trajectory T_{P} according to rewards given by θ. Then, the present invention applies importance sampling to sample trajectories that need to be trained for both the expert and the policy. For a given set of trajectories, the reward function generates rewards to compute GLL and D_{KL}, and the gradient is updated to minimize a computed loss. During the learning process, the reward function may generate samples multiple times using the learned parameters. However, since a single reward value is used for novelty detection, the learned mean value should be used.

For the policy gradient algorithm, the present invention uses proximal policy optimization (PPO), which limits policy updates of the actor-critic policy gradient algorithm using surrogate gradient clipping and a Kullback-Leibler penalty and which is a state-of-the-art policy optimization method. The overall algorithm of the learning process according to the present invention is equal to Algorithm 1 below.

[Algorithm 1]

Obtain expert trajectories T_{E};

Initialize policy network π;

Initialize reward network θ;

for iteration n=1 to N do

Generate T_{P} from π;

Apply importance sampling to T_{E}\hat{ } and T_{P}\hat{ };

Obtain n samples of R_{E} and R_{P} from θ using T_{E}\hat{ } and T_{P}\hat{ };

Compute ELBO(θ) using R_{E} and R_{P};

Update parameters using gradient ∇₀ELBO(θ);

Update π with respect to R_{P} using PPO;

Detection of Delivery Means (Detection of Abuser)

After the reward function is learned, test trajectories may be directly input to the reward function to obtain appropriate reward values. Here, the present invention computes a novelty score of each test trajectory through Formula 10 below.

n(τ)=r₀(τ)−μᵣ/σᵣ [Formula 10]

Here, μᵣ and σᵣ denote the mean and the standard variation for all test rewards, and r₀(τ) denotes a single reward value of a given single τ, which is a state-action pair.

The present invention applies mean absolute deviation (MAD) for automated novelty detection, which is commonly used in a novelty or outlier detection metric.

In the present invention, the coefficient of MAD is expressed as k in Equation 11 below, and k is set to 1, which yields the best performance based on empirical experiments. After experimenting with the result distributions of rewards through multiple test runs, it was empirically confirmed that the posterior of the rewards followed a half-Gaussian or half-Laplacian distribution. Therefore, the present invention defines an automated critical value ε for novelty detection as expressed in Formula 11 below.

ε=min(n)+kσ²ₙ [Formula 11]

Here, min(n) denotes the minimum value, and σₙ denotes the standard deviation of all novelty score values from the minimum.

Since it is assumed that the prior distribution of rewards is zero-mean Gaussian, it may be assumed that min(n) of the posterior is close to zero. Consequently, the present invention can define a point-wise novelty for trajectories in which n(T)>ε. Since the purpose of RL is to maximize an expected return, trajectories with high returns may be considered as novelties in the problem according to the present invention. When a point belongs to the trajectory of an abuser, the present invention defines the point in the trajectory as a point-wise novelty. Since the present invention aims to classify sequences, the present invention defines trajectories containing point-wise novelties in a specific proportion as a trajectory-wise novelty. Since the action patterns of delivery workers are very similar regardless of their vehicle type, the present invention expects a small proportion of point-wise novelties compared to the length of the sequence. Accordingly, the present invention defines trajectory-wise novelties as trajectories having 10% or 5% point-wise novelties.

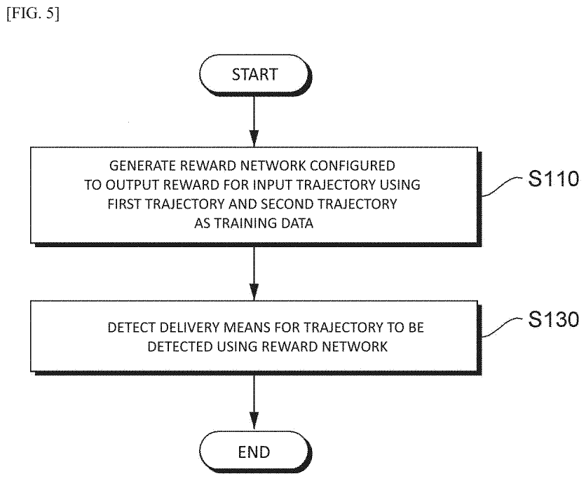

Next, the inverse reinforcement learning-based delivery means detection method according to a desired embodiment of the present invention will be described in detail with reference to FIGS. 5 to 7.

FIG. 5 is a flowchart illustrating the steps of the inverse reinforcement learning-based delivery means detection method according to a desired embodiment of the present invention.

Referring to FIG. 5, the delivery means detection apparatus 100 generates a reward network configured to output a reward for an input trajectory using a first trajectory and a second trajectory as training data (S110).

Then, the delivery means detection apparatus 100 detects a delivery means for a trajectory to be detected using the reward network (S130).

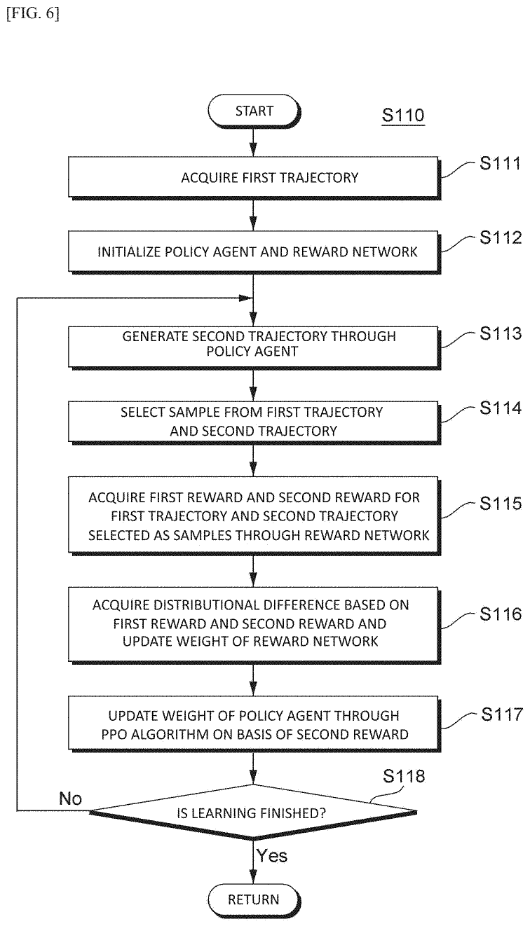

FIG. 6 is a flowchart illustrating the sub steps of a reward network generation step shown in FIG. 5.

Referring to FIG. 6, the delivery means detection apparatus 100 may acquire a first trajectory (S111). Here, the first trajectory is a trajectory acquired from the driving record of the actual delivery worker and may include a state-action pair. The state indicates the current static state and may include information on latitude, longitude, interval, distance, speed, cumulative distance, and cumulative time. The action indicates an action taken dynamically in the corresponding state and may include information on velocity in the x-axis direction, velocity in the y-axis direction, and acceleration.

Then, the delivery means detection apparatus 100 may initialize a policy agent and a reward network (S112). That is, the delivery means detection apparatus 100 may initialize the weight of the reward network and the weight of the policy agent using a Gaussian distribution.

Subsequently, the delivery means detection apparatus 100 may generate a second trajectory through the policy agent (S113). Here, the second trajectory is a trajectory obtained by imitating the action from the state of the first trajectory and may include a pair of the state of the first trajectory and the action imitated based on the state of the first trajectory. In this case, the delivery means detection apparatus 100 may generate the policy agent configured to output an action for an input state using the state of the first trajectory as training data. The delivery means detection apparatus 100 may acquire an action for the state of the first trajectory through the policy agent and may generate the second trajectory on the basis of the state of the first trajectory and the acquired action.

Also, the delivery means detection apparatus 100 may select a sample from the first trajectory and the second trajectory (S114). That is, the delivery means detection apparatus 100 may select a portion of the second trajectory as a sample through an importance sampling algorithm and may acquire, from the first trajectory, a sample corresponding to the portion of the second trajectory selected as the sample.

Then, the delivery means detection apparatus 100 may acquire a first reward and a second reward for the first trajectory and the second trajectory selected as samples through the reward network (S115).

Subsequently, the delivery means detection apparatus 100 may acquire a distributional difference on the basis of the first reward and the second reward and update the weight of the reward network (S116). For example, the delivery means detection apparatus 100 may acquire a distributional difference between rewards through an evidence of lower bound (ELBO) optimization algorithm on the basis of the first reward and the second reward and may update the weight of the reward network.

Also, the delivery means detection apparatus 100 may update the weight of the policy agent through the proximal policy optimization (PPO) algorithm on the basis of the second reward (S117).

When the learning is not finished (S118-N), the delivery means detection apparatus 100 may perform steps S113 to S117 again.

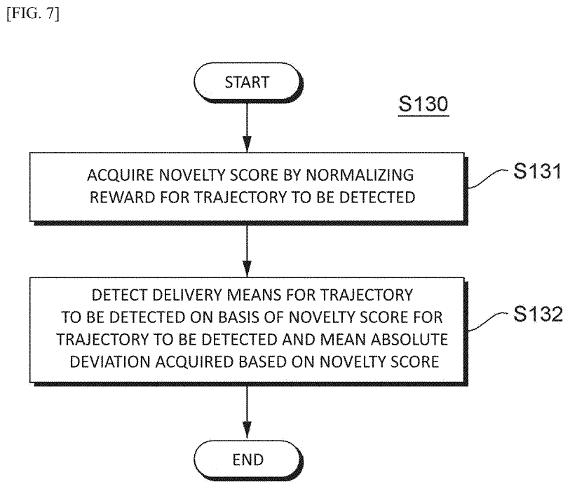

FIG. 7 is a flowchart illustrating the sub steps of a delivery means detection step shown in FIG. 5.

Referring to FIG. 7, the delivery means detection apparatus 100 may acquire a novelty score by normalizing the reward for the trajectory to be detected (S131).

Then, the delivery means detection apparatus 100 may detect a delivery means for the trajectory to be detected on the basis of the novelty score for the trajectory to be detected and the mean absolute deviation (MAD) acquired based on the novelty score (S132).

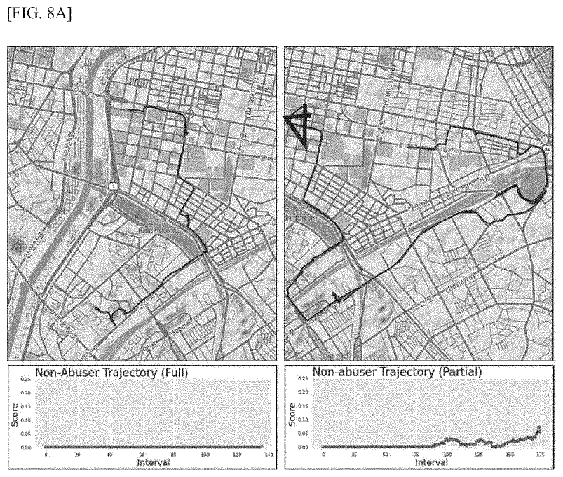

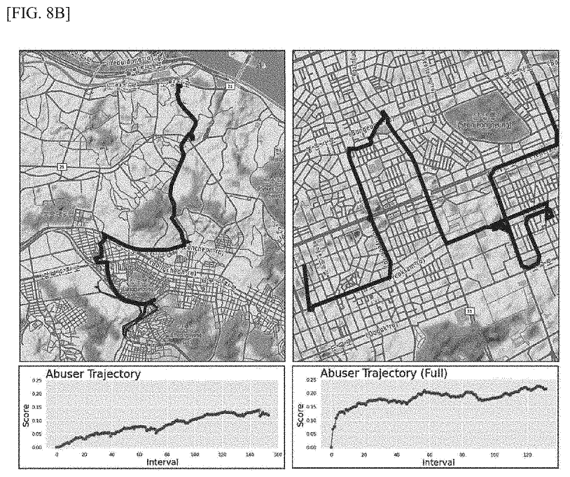

Next, the performance of the inverse reinforcement learning-based delivery means detection operation according to a desirable embodiment of the present invention will be described with reference to FIGS. 8A and 8B.

In order to compare the performance of the inverse reinforcement learning-based delivery means detection operation according to the present invention, the following seven techniques were used to detect novelties or outliers.

Local outlier factor (LOF): An outlier detection model based on clustering and density, which measures a distance to the closest k neighbor of each data point as density in order to define higher density points as novelties

Isolation forest (ISF): A novelty detection model based on a bootstrapped regression tree, which recursively generates partitions in a data set to separate outliers from normal data

One class support vector machine (OC-SVM): A model that learns the boundary of points of the normal data and classifies data points outside the boundary as outliers

Feed-forward neural network autoencoder (FNN-AE): An automatic encoder implemented using only fully connected layers

Long short-term memory autoencoder (LSTM-AE): A model including an LSTM encoder and an LSSTM decoder in which a hidden layer operates with encoding values and in which one fully connected layer is added to an output layer

Variational autoencoder (VAE): A model including an encoder that encodes given data into latent variables (mean and standard deviation)

Inverse reinforcement learning-based anomaly detection (IRL-AD): A model that uses a Bayesian neural network with a k-bootstrapped head

One class classification was performed on test data, and performance was evaluated using precision, recall, Fl-score, and AUROC score. Also, in order to effectively classify two classes with undistorted accuracy in one class, the number of false positives and the number of false negatives were measured to measure model validity considering real-world scenarios.

Table 1 below shows the result of all methods that classify sequences at a novelty rate of 5%, and Table 2 below shows the result of all methods that classify sequences at a novelty rate of 10%.

TABLE 1

| | 5% Novelty Rate | | | | | |
|---|---|---|---|---|---|---|
| Method | Precision | Recall | F₁ | AUROC | FPR | FNR |
| LOF | .389 | .133 | .199 | .490 | 221 | 913 |
| ISF | .435 | .490 | .461 | .511 | 670 | 538 |
| OC-SVM | .576 | 1.0 | .731 | .500 | 1054 | 0 |
| FNN-AE | .413 | .668 | .511 | .459 | 1240 | 222 |
| LSTM-AE | .440 | .800 | .568 | .517 | 1087 | 213 |
| VAE | .436 | .953 | .598 | .513 | 1315 | 50 |
| IRL-AD | .728 | .593 | .654 | .713 | 434 | 237 |
| INVENTION | .860 | .678 | .758 | .797 | 344 | 118 |

Here, FPR denotes false positive rate, and FNR denotes false negative rate.

TABLE 2

| | 10% Novelty Rate | | | | | |
|---|---|---|---|---|---|---|
| Method | Precision | Recall | F₁ | AUROC | FPR | FNR |
| LOF | .412 | .479 | .443 | .487 | 772 | 549 |
| ISF | .420 | .770 | .544 | .495 | 1117 | 242 |
| OC-SVM | .576 | 1.0 | .731 | .500 | 1054 | 0 |
| FNN-AE | .405 | .792 | .546 | .477 | 1012 | 354 |
| LSTM-AE | .432 | .908 | .586 | .506 | 1272 | 98 |
| VAE | .433 | .981 | .601 | .508 | 1369 | 20 |
| IRL-AD | .673 | .641 | .656 | .703 | 383 | 333 |
| INVENTION | .850 | .707 | .772 | .806 | 313 | 113 |

According to Table 1 and Table 2, it can be confirmed that the present invention achieved a higher score compared to IRL-AD, which showed the second best performance in AUROC score, and showed performance that surpasses any other methods. That is, it can be confirmed that the present invention achieved a higher score compared to OC-SVM, which showed the second best performance in F₁ score. Also, it can be confirmed that the present invention exhibited better performance than other techniques in FPR and FNR.

FIGS. 8A and 8B are diagrams illustrating the performance of the inverse reinforcement learning-based delivery means detection operation according to a desirable embodiment of the present invention.

According to the present invention, the sample trajectories of the abuser and non-abuser classified from the test dataset are shown in FIGS. 8A and 8B. FIG. 8A shows the trajectory of the non-abuser, and FIG. 8B shows the trajectory of the abuser

The left drawing of FIG. 8A shows the trajectory of the non-abuser based on the novelty score displayed on the bottom, and it can be confirmed that all data points of the sequence are classified as non-abusers. The right drawing of FIG. 8A shows that the middle numerical value has some novelties due to GPS malfunction and that novelty scores for most data points are non-abusers.

In the left drawing of FIG. 8B, most data points are classified as novelties starting from the 23rd data point, and the trajectory is classified as an abuser. In the right drawing of FIG. 8B, almost all data points are classified as novelties, and the trajectory is classified as that of an abuser.

In this way, the present invention enables the result to be visualized.

Although all the components constituting the embodiments of the present invention described above are described as being combined into a single component or operated in combination, the present invention is not necessarily limited to these embodiments. That is, within the scope of the object of the present invention, all the components may be selectively combined and operated in one or more manners. In addition, each of the components may be implemented as one independent piece of hardware and may also be implemented as a computer program having a program module for executing some or all functions combined in one piece or a plurality of pieces of hardware by selectively combining some or all of the components. Also, the computer program may be stored in a computer-readable recording medium, such as a Universal Serial Bus (USB) memory, a compact disc (CD), or a flash memory, and read and executed by a computer to implement the embodiments of the present invention. The recording medium of the computer program may include a magnetic recording medium, an optical recording medium, and the like.

The above description is merely illustrative of the technical spirit of the present invention, and those of ordinary skill in the art can make various modifications, changes, and substitutions without departing from the essential characteristics of the present invention. Accordingly, the embodiments disclosed in the present invention and the accompanying drawings are not intended to limit but rather to describe the technical spirit of the present invention, and the technical scope of the present invention is not limited by these embodiments and the accompanying drawings. The scope of the invention should be construed by the appended claims, and all technical spirits within the scopes of their equivalents should be construed as being included in the scope of the invention.

### DESCRIPTION OF REFERENCE NUMERALS

100: Delivery means detection apparatus

110: Reward network generation unit

130: Delivery means detection unit

1. An inverse reinforcement learning-based delivery means detection apparatus comprising:
a reward network generation unit configured to generate a reward network that outputs a reward for an input trajectory using, as training data, a first trajectory including a pair of a state, which indicates a current static state, and an action, which indicates an action dynamically taken in the state, and a second trajectory including a pair of the state of the first trajectory and an action imitated based on the state of the first trajectory; and
a delivery means detection unit configured to acquire a reward for a trajectory to be detected from the trajectory to be detected using the reward network and detect a delivery means for the trajectory to be detected on the basis of the reward for the trajectory to be detected.

2. The inverse reinforcement learning-based delivery means detection apparatus of claim 1, wherein the reward network generation unit is configured to:
generate a policy agent configured to output an action for an input state using the state of the first trajectory as training data;
acquire an action for the state of the first trajectory through the policy agent; and
generate the second trajectory on the basis of the state of the first trajectory and the acquired action.

3. The inverse reinforcement learning-based delivery means detection apparatus of claim 2, wherein the reward network generation unit is configured to update the weight of the policy agent through a proximal policy optimization (PPO) algorithm on the basis of a second reward for the second trajectory acquired through the reward network.

4. The inverse reinforcement learning-based delivery means detection apparatus of claim 2, wherein the reward network generation unit is configured to:
acquire a distributional difference between rewards on the basis of a first reward for the first trajectory acquired through the reward network and a second reward for the second trajectory acquired through the reward network; and
update the weight of the reward network.

5. The inverse reinforcement learning-based delivery means detection apparatus of claim 4, wherein the reward network generation unit is configured to:
acquire the distributional difference between the rewards through an evidence of lower bound (ELBO) optimization algorithm on the basis of the first reward and the second reward; and
update the weight of the reward network.

6. The inverse reinforcement learning-based delivery means detection apparatus of claim 2, wherein the reward network generation unit is configured to:
initialize the weight of the reward network and the weight of the policy agent using a Gaussian distribution; and
generate the reward network and the policy agent through an iterative learning process.

7. The inverse reinforcement learning-based delivery means detection apparatus of claim 2, wherein the reward network generation unit is configured to:
select a portion of the second trajectory as a sample through an importance sampling algorithm;
acquire, from the first trajectory, a sample corresponding to the portion of the second trajectory selected as the sample; and
generate the reward network using, as training data, the portion of the first trajectory acquired as the sample and the portion of the second trajectory acquired as the sample.

8. The inverse reinforcement learning-based delivery means detection apparatus of claim 2, wherein the delivery means detection unit acquires a novelty score by normalizing the reward for the trajectory to be detected and detects a delivery means for the trajectory to be detected on the basis of the novelty score for the trajectory to be detected and a mean absolute deviation (MAD) acquired based on the novelty score.

9. The inverse reinforcement learning-based delivery means detection apparatus of claim 1, wherein
the state includes information on latitude, longitude, interval, distance, speed, cumulative distance, and cumulative time,
the action includes information on velocity in the x-axis direction, velocity in the y-axis direction, and acceleration, and
the first trajectory is a trajectory acquired from a driving record of an actual delivery worker.

10. A delivery means detection method performed by an inverse reinforcement learning-based delivery means detection apparatus, the inverse reinforcement learning-based delivery means detection method comprising steps of:
generating a reward network that outputs a reward for an input trajectory using, as training data, a first trajectory including a pair of a state, which indicates a current static state, and an action, which indicates an action that is dynamically taken in the state, and a second trajectory including a pair of the state of the first trajectory and an action imitated based on the state of the first trajectory; and
acquiring a reward for a trajectory to be detected from the trajectory to be detected using the reward network and detecting a delivery means for the trajectory to be detected on the basis of the reward for the trajectory to be detected.

11. The inverse reinforcement learning-based delivery means detection method of claim 10, wherein the step of generating the reward network comprises generating a policy agent configured to output an action for an input state using the state of the first trajectory as training data, acquiring an action for the state of the first trajectory through the policy agent, and generating the second trajectory on the basis of the state of the first trajectory and the acquired action.

12. The inverse reinforcement learning-based delivery means detection method of claim 11, wherein the step of generating the reward network comprises updating the weight of the policy agent through a proximal policy optimization (PPO) algorithm on the basis of a second reward for the second trajectory acquired through the reward network.

13. The inverse reinforcement learning-based delivery means detection method of claim 11, wherein the step of generating the reward network comprises acquiring a distributional difference between rewards on the basis of a first reward for the first trajectory acquired through the reward network and a second reward for the second trajectory acquired through the reward network and updating the weight of the reward network.

14. The inverse reinforcement learning-based delivery means detection method of claim 11, wherein the step of generating the reward network comprises selecting a portion of the second trajectory as a sample through an importance sampling algorithm, acquiring, from the first trajectory, a sample corresponding to the portion of the second trajectory selected as the sample, and generating the reward network using, as training data, the portion of the first trajectory acquired as the sample and the portion of the second trajectory acquired as the sample.

15. A computer program stored in a computer-readable recording to execute, in a computer, the inverse reinforcement learning-based delivery means detection method according to claim 10.
